(19) United States
(12) Patent Application Publication
(10) Pub. No.: US 2010/0060629 A1
(43) Pub. Date: Mar. 11, 2010

(54) Graphics-Processing Architecture Based on Approximate Rendering

(76) Inventors: Jim Rasmusson, Vellinge (SE); Tomas Akenine-Moller, Lund (SE); Petrik Clarberg, Lund (SE); Jon Hasselgren, Bunkeflostrand (SE); Jacob Munkberg, Malmo (SE)

Correspondence Address: COATS & BENNETT, PLLC, 1400 Crescent Green, Suite 300, Cary, NC, 27518, US

(21) Appl. No.: 12/207,095

(22) Filed: Sep. 9, 2008

(51) Int. Cl. G06T 15/00

(52) U.S. Cl. 345/419

(57) ABSTRACT

A graphics processing circuit for rendering three-dimensional graphics data is disclosed. The circuit includes pipelined graphics processing stages, wherein each of two or more of the stages is configured to process at least one of graphics primitives, vertices, tiles, and pixels, according to a stage-specific error budget. Depending on its error budget, each of these stages may select a high- or low-precision calculation, select between lossless and lossy compression, adjust the compression ratio of a variable lossy compression algorithm, or some combination of these approaches. The circuit further comprises a global error-control unit configured to determine error budgets for each of the two or more stages, based on at least one of error data received from the two or more stages, predetermined scene complexity data, and user-defined error settings, and to assign the error budgets to the graphics processing stages. Corresponding methods for processing graphics data are also disclosed.

### BACKGROUND

The present invention generally relates to the processing of graphics data, and particularly relates to methods and apparatus for controlling approximation errors in the rendering of three-dimensional graphics data.

State-of-the-art three-dimensional (3-D) graphics processing systems typically render graphical images using algorithms with high numerical precision. Thus, a graphics processing unit (GPU) might use 32-bit floating-point precision throughout the graphics pipeline, rather than 16-bit arithmetic. This reflects a generally conservative approach to the design of graphics processing circuits and algorithms. Each block of a graphics processing pipeline is generally designed to handle the worst case scenarios with respect to error accumulation.

Another outcome of this conservative approach to graphics pipeline design is that data compression, which may be utilized at various stages of the pipeline to reduce the required memory bandwidth (the capacity for writing data to memory and reading data from memory), is conventionally performed using lossless compression algorithms. The use of lossless compression algorithms guarantees that the original data is exactly reconstructed upon de-compression, preventing the introduction of compression-induced visible “artifacts” in the rendered images. Of course, there are exceptions to the use of lossless compression algorithms. For example, texture compression algorithms are often lossy. (One example of a lossy texture compression algorithm is the Ericsson Texture Compression algorithm, which is standardized as part of the OpenGL ES 2.0× specification for programmable 3-D graphics pipelines published by the Khronos Group, Inc.) However, other data, such as color buffer data or depth-buffer data, is generally compressed using lossless algorithms, yielding generally lower compression ratios than would be achievable with lossy algorithms.

This conservative approach to graphics pipeline design yields graphics processing solutions that consume more electrical power than is necessary, and that require large memory bandwidths for handling the various buffers typically utilized during the graphics rendering process, such as texture buffers, depth buffers (often called z-buffers), and color buffers. These buffers often are stored in random-access memory (RAM) external to the graphics processing unit (GPU), which may have relatively small cache memories on board. Because the buffered data may be retrieved and re-written several times during the rendering process, the memory bandwidth must often be quite high, especially to support real-time graphics processing applications such as real-time games. On a desktop personal computer, the available memory bandwidth might be very high, perhaps several gigabytes per second. In a mobile phone, several hundred megabytes per second of data transfer might be available.

Even with these high available memory bandwidths, the performance of a GPU might nonetheless be constrained by the memory bandwidth. Reducing the amount of data retrieved from and written to the external RAM is thus generally advantageous. The advantages of reducing memory transactions are particularly pronounced in power-sensitive mobile platforms, such as a mobile telephone, since the increased clock rates and wider data buses required to support very high memory bandwidths also result in increased power consumption, draining batteries more quickly.

Data compression is one approach to reducing the memory bandwidth required to support advanced 3-D rendering applications. Lossy data compression algorithms can provide high compression ratios, but may sometimes result in the introduction of visual artifacts into the rendered images, especially when lossy compression is used several times during the rendering of a single graphics frame. The need for repeated compression and decompression operations distinguishes many 3-D graphics rendering applications from digital video applications, for instance, where a given frame is typically compressed just once. Some or all of the color buffer data for a single frame may be compressed and decompressed several times during the graphics rendering process. In a triangle-based 3-D rendering system, for example, several triangles may be successively written to a segment (e.g., a tile, or block) of data. Each time, the segment of data may be retrieved from the frame buffer, decompressed, processed, updated as necessary, compressed again, and written back to the color buffer. If lossy compression is used to compress the data segment each time, this tandem compression may result in repeated incremental losses of information, introducing unacceptable errors into the final data.

Reducing the precision of numerical calculations is another method of reducing processing power requirements and/or memory bandwidths. However, this approach might also lead to undesired artifacts in the rendered images under some circumstances. This may be especially true when reduced-precision calculations are used in conjunction with more complex lossy data compression schemes. (Those skilled in the art will appreciate that reducing numerical precision in graphics processing calculations can be viewed as a simple form of lossy compression, in that both techniques approximate the original data, with a savings in data size. Although these techniques are often discussed separately herein, references to lossy compression techniques in the text that follows should be understood to include the reduction of numerical precision, unless the context clearly indicates otherwise.)

Notwithstanding the above problems, it is more important in many applications, especially in applications designed for mobile devices, to minimize power consumption and memory bandwidth, and to maximize the responsiveness of the graphics processing system, than to guarantee perfectly artifact-free images. In these situations, conventional graphics processing architectures, designed for worst-case scenarios, provide a sub-optimal allocation of graphics processing resources.

### SUMMARY

In various embodiments of the graphics processing architecture described herein, the processing precision requirements for one or more blocks of a graphics pipeline are relaxed. This may mean that reduced-precision calculations are employed in some blocks, or that more complex lossy (approximate) compression methods are used. However, the techniques disclosed herein permit the errors introduced by these relaxed-precision techniques to be bounded by local error-control mechanisms specific to each of several stages of the graphics pipeline. Furthermore, a global error-control mechanism may be configured to monitor the errors introduced by stage-specific approximations, and to set error budgets for one or more of the stages. The architecture described herein thus provides a comprehensive mechanism for trading bounded degradation of image quality for increased performance and/or energy savings.

Thus, according to some embodiments of the present invention, a graphics processing circuit for rendering three-dimensional graphics data includes a graphics pipeline comprising pipelined processing stages, wherein each of two or more of the stages is configured to process vertices, pixels, graphics primitives, tiles, or other graphical data, according to a stage-specific error budget. Depending on its error budget, each of these stages may select a high- or low-precision calculation, select between lossless and lossy compression, adjust the compression ratio of a variable lossy compression algorithm, or some combination of these approaches. The graphics processing circuit in these embodiments further comprises a global error-control unit configured to determine error budgets for each of the two or more stages, based on at least one of error data received from the two or more stages, predetermined scene complexity data, and user-defined error settings, and to assign the error budgets to the stages.

In some embodiments, the error data produced by one or more stages may comprise measured error data. In some embodiments, the error data may instead comprise estimated error data. This latter approach may be more applicable to processing stages where the output from an approximate processing technique cannot be directly compared to the output that would have resulted from a more exact technique. In some embodiments, error data reported to the global error-control unit may comprise a statistical error measure, such as a mean error or peak error, corresponding to a group of pixels, vertices, or both. For instance, a processing stage may report a statistical error measure corresponding to an entire frame, or to a series of pixel, tile (a group of pixels processed together), or vertex processing operations, rather than reporting error data corresponding to each pixel or to each tile.

In some embodiments of the invention, the global error-control unit is configured to calculate an accumulated error based on error data collected from two or more stages of the pipeline and to adjust the error budget for at least one stage based on the accumulated error. In some of these embodiments, the global error-control unit compares recent error data to previously received error data and adjusts the error budget for at least one stage based on the comparison. For instance, a significant increase in an accumulated error measure compared to previously recorded accumulated errors may warrant a decrease in the error budget allocated to one or more stages. In some cases, such an increase in the error may warrant an instruction to discontinue approximation techniques altogether.

In some embodiments, the calculation of error budgets to be allocated to one or more stages of the graphics pipeline is based on a user setting instead of or in addition to the error data reported from the pipelined processing stages. This approach allows the user a degree of control over the tradeoff between graphics performance and battery life, for example. In other embodiments, the calculation of error budgets may be based on a complexity metric for one or more frames, instead of or in addition to the error data collected from the pipelined stages. In still other embodiments, the error budget calculation may be at least partly based on a target frame-rendering time, so that frame-rendering times may be limited or kept nearly uniform.

The methods and apparatus taught herein thus provide a novel approach to the use of approximation techniques in graphics processing applications. Although more generally applicable, these methods and apparatus are particularly useful in real-time, polygon-based, 3-D rendering applications. Those skilled in the art will appreciate that the methods and apparatus disclosed herein may be applied to reduce the memory bandwidth requirements for a given graphics application, to facilitate more advanced graphics processing, or both. Those skilled in the art will also appreciate that the techniques disclosed herein may provide particular advantages in a battery-powered portable device, such as a mobile phone, where higher memory bandwidth requirements generally result in increased energy consumption and shorter battery life.

Methods generally corresponding to various embodiments of the graphics processing circuit described above are also disclosed herein. An exemplary method for processing three-dimensional graphics data includes determining a stage-specific error budget for each of two or more pipelined graphics processing stages, based on at least one of error data collected from the two or more stages, predetermined scene complexity data, and user-defined error settings. The method further comprises assigning the error budgets to the two or more stages, and processing vertices, pixels, graphics primitives, tiles, or other graphical data, in each of the stages, according to the assigned stage-specific error budget. In some embodiments, the method further comprises collecting error data from each of the two or more stages, for use in determining the error budgets. Variations of this general method are also detailed herein.

Of course, the present invention is not limited to the above features and advantages. Those skilled in the art will recognize additional features and advantages upon reading the following detailed description, and upon viewing the accompanying drawings.

### BRIEF DESCRIPTION OF THE DRAWINGS

FIG. 1 is a block diagram of an exemplary graphics processing circuit according to some embodiments of the invention.

FIG. 2 is a logic flow diagram illustrating an exemplary stage-specific error-control process.

FIG. 3 is a flow diagram illustrating an exemplary general method for processing graphics data according to some embodiments of the present invention.

FIG. 4 illustrates the selection of an approximation technique by a graphics processing stage, based on an assigned stage-specific error budget.

FIG. 5 is a logic flow diagram illustrating an exemplary approach to adjusting an error budget for one or more stages of a pipelined graphics processor.

FIG. 6 is a logic flow diagram illustrating the application of the disclosed error-control techniques in a pre-processing scenario.

FIG. 7 is a logic flow diagram illustrating an exemplary calculation of an error budget based on user input and a target frame-rendering time, in addition to stage error data.

### DETAILED DESCRIPTION

The various methods and circuits disclosed herein relate to the processing of graphics data and to techniques for controlling approximation errors during graphics data processing. Although the embodiments described herein are generally illustrated in the more specific context of real-time rendering of three-dimensional graphics data, those skilled in the art will appreciate the broader applicability of these techniques. Furthermore, although several of the approximation techniques described herein are discussed with respect to a particular processing stage or type of graphics data, such as the color buffer compression schemes discussed below, those skilled in the art will appreciate that many of these techniques may be applied in other stages and/or to other graphics data, such as texture buffer data, depth buffer data, or intensity data. Using the disclosed schemes, the quantity of graphics data that must be buffered may be reduced, the number of rendering calculations reduced, or both, thus reducing the memory bandwidth required for storing and retrieving the graphics data or freeing memory bandwidth for more advanced and/or more rapid graphics processing. As disclosed herein, lossy compression techniques and other approximation techniques may be used to achieve savings in memory bandwidth and/or power consumption, while keeping accumulated errors introduced by the approximation operations to acceptable levels.

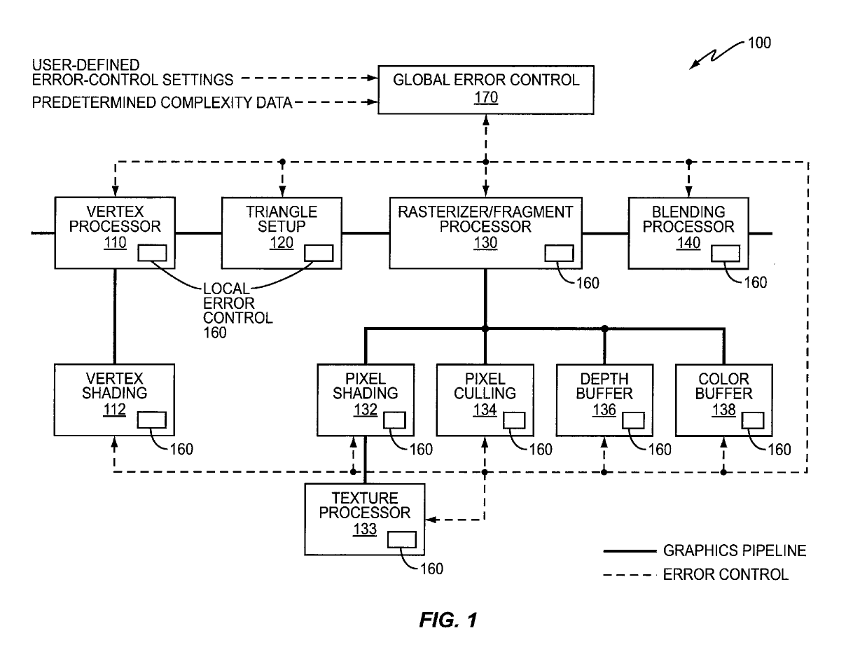

FIG. 1 illustrates a block diagram of an exemplary graphics processing circuit 100 according to some embodiments of the present invention. Those skilled in the art will recognize the general functions of the pipelined graphics processing blocks, or stages, as each of these stages corresponds to counterparts in conventional graphics processing stages. In particular, vertex processor 110, triangle setup block 120, rasterizer/fragment processor 130, and blending processor 140 perform well-known graphics rendering operations, the details of which are not necessary to a complete understanding of the present invention. Likewise, vertex shading block 112, pixel shading block 132, pixel culling block 134, depth buffer 136, color buffer 138, and texture processor 133 also perform graphics processing operations corresponding to their counterparts in various conventional graphics processing units (GPUs). Those skilled in the art will further appreciate, upon a complete reading of the present disclosure, that the inventive techniques described herein are not limited to the particular circuit configuration of FIG. 1.

The graphics pipeline of FIG. 1 processes input data comprising polygon data, which in turn comprises vertices (describing triangles, for instance) along with associated attributes. For the representative pipeline illustrated in FIG. 1, processing begins at vertex processor 110 and ends at blending processor 140, with graphics data flows indicated by solid lines between stages. Output is generated from the blending processor in the form of final pixels, which are stored in an external frame buffer or sent directly to a device display sub-system.

One or more of the processing stages of the graphics processing circuit 100 includes a local error-control unit 160. In the embodiment pictured in FIG. 1, every processing stage includes a local error-control unit 160. In other embodiments only a subset of the processing stages may include a local error-control unit 160.

In some embodiments, one or more of the local error-control units 160 evaluates whether an approximation technique can be performed for a current graphics processing operation and selects an appropriate technique. The selection of a particular technique is based, at least in part, on an error budget assigned by global error-control unit 170, as will be described in more detail below. Based on this error budget, the error-control unit 160 for some stages may further determine the degree of approximation that may be utilized. Thus, a local error-control unit 160 may evaluate whether 16-bit floating-point precision may be utilized instead of 32-bit precision, whether a lossy compression scheme may be employed, or whether other quantization or sub-sampling schemes may be used. Other local error-control units, in these same embodiments or in other embodiments, may instead receive specific instructions, designating a specific approximation technique and/or a degree of approximation to be used, from the global error control unit 170. Those skilled in the art will appreciate that the particular options available for a given processing stage will depend on the operations performed by that stage, since some approximation techniques are more appropriate for some operations than for others. Further, the availability of various approximation schemes may also be limited by the desired complexity of the stage or the overall processing pipeline.

In addition to evaluating and selecting an approximation technique, in some embodiments one or more of the local error-control units 160 are also configured to report error data to the global error-control unit 170. Some of these local error-control units 160 may accurately track the error introduced by the selected approximation technique by measuring the error; others may estimate the introduced error. In some embodiments, the error data reported by one or more stages may simply indicate that the introduced error corresponds to one of several pre-determined error levels, such as “high,” “medium,” and “low,” or may indicate which of two or more pre-determined approximation techniques was used in a recent or current operation. Thus, the error data reported to global error-control unit 170 may include measured error data, estimated error data, error statistics (such as mean-square error, peak error, etc.), process descriptors, or the like. In FIG. 1, the flow of error data from processing stages to global error-control unit 170 is illustrated with dashed lines.

In general, the global error-control unit is configured to determine error budgets for the graphics processing stages based on error data received from the two or more stages, predetermined scene complexity data, user-defined error-control settings, or some combination thereof. The global error-control unit 170 is thus configured, in some embodiments, to calculate error budgets for one or more of the processing stages using error data received from the stages as described above. Thus, generally speaking, the global error-control unit 170 communicates with each of the local error-control units 160, exchanging local and/or global error metrics. The global error-control unit 170 may provide configuration parameters, such as error thresholds, specific approximation settings, or the like, to the various pipelined processing stages. These parameters are generally referred to herein as “error budgets,” with the understanding that these error budgets are not necessarily limited to parameters defining a maximum error permitted for a given processing stage.

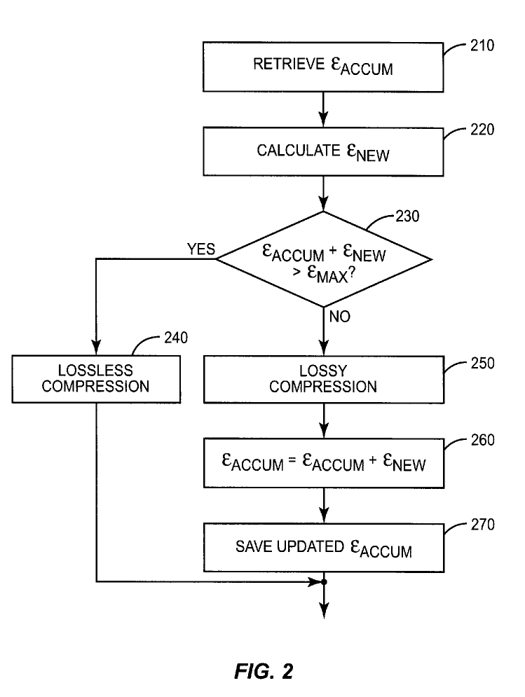

FIG. 2 illustrates an exemplary stage-specific error-control process that might be employed in one or more of the processing stages of FIG. 1. The portion of a rendering process illustrated by FIG. 2 “begins” mid-process, as illustrated at block 210, with the retrieval of a locally accumulated error metric, ε_{ACCUM}. This error metric represents the error introduced by the stage so far in the ongoing processing of a frame, tile, pixel, vertex, graphics primitive, and the like, and may represent a measurement of actual error, in stages where an error-free version of the data (e.g. uncompressed data) is available to compare with the approximated data, or an estimate of the introduced error. At block 220, the incremental error to be introduced by the next step of the processing, ε_{NEW}, is calculated; again, this might be a calculation of an actual error, or an estimate based on an error model for the approximation technique.

At block 230, the new error is tested to see if the total accumulated error will exceed an error budget, ε_{MAX}, assigned to the graphics processing stage. Thus, if ε_{ACCUM}+ε_{NEW}>ε_{MAX}, then no further error accumulation is permitted. In this case, lossless compression is performed, as shown at block 240. On the other hand, if ε_{ACCUM}+ε_{NEW}≦ε_{MAX}, then the introduction of further error is permitted, and lossy compression is performed, as shown at block 250. In this latter case, the accumulated error metric ε_{ACCUM} is updated, as shown at block 260, by adding the incremental error of the compression step, ε_{NEW}, to the prior value for the accumulated error metric. At block 270, the updated error metric ε_{ACCUM} is saved, for use in subsequent error-control loops.

As illustrated by the exemplary process of FIG. 2, the local error-control units 160 in the stages of the graphics pipeline may utilize one or more accumulated error metrics. At each instance where an error is about to be introduced, a test may be implemented to determine whether a stage-specific error budget is about to be exceeded. If it is, a particular approximation technique is not used, or the degree of approximation is adjusted, to keep the accumulated error under control. Although FIG. 2 is directed in particular to an error-control process that selects between a lossy compression algorithm and a lossless compression algorithm, those skilled in the art will appreciate that similar processes may be utilize to select among other approximation techniques, such as for example, the selection of reduced precision in one or more components of a color space (e.g., the UV channels of the YUV color space). Thus, in other stages one or more of these other techniques may be used instead of or in addition to a lossy or lossless compression scheme.

As noted above, error data reported by one or more processing stages may be used by the global error-control unit 170 to calculate and assign error budgets to processing stages. This error data may comprise, in some embodiments, an accumulated stage-specific error metric for a particular stage. In some embodiments, error data may comprise one or more parameters indicating which of one or more possible approximation techniques is currently being used by a given stage, or indicating a degree of approximation currently employed. Thus, those skilled in the art will understand that the error data provided to global error-control unit 170 may comprise numerical error data or other data that more indirectly quantifies the error introduced by a given processing stage.

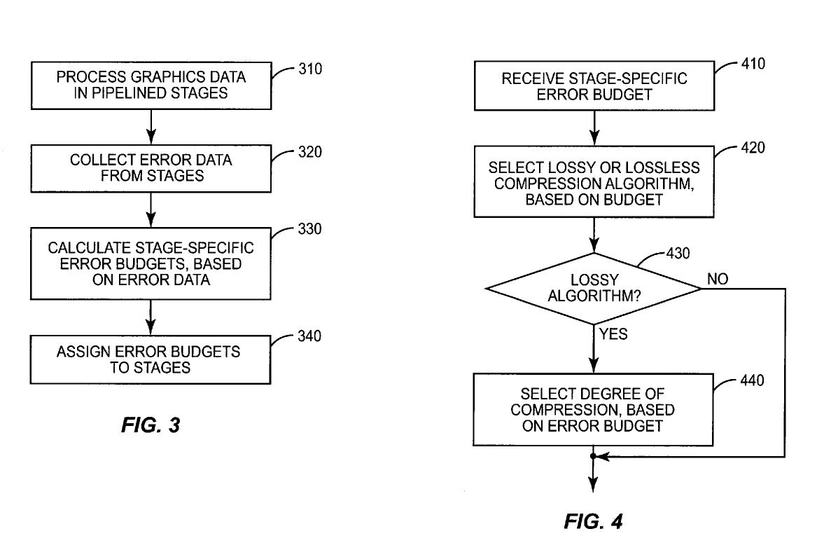

FIG. 3 illustrates a general process for allocating error budgets to one or more stages of a pipelined graphics processing system. This process “begins,” as illustrated at block 310, with the processing of graphics data in pipelined stages. Some of these stages may use one or more of the approximation techniques discussed above, such as a lossy compression scheme, a reduced-precision computation, or the like.

At block 320, error data is collected from each of several stages. This error data, as described above, may comprise numerical data directly quantifying the error introduced by a stage-specific process, or may comprise one or more parameters indicating the type of process employed, or a relative degree of approximation.

The error data is used, as shown at block 330, to calculate stage-specific error budgets, which are assigned to the graphics processing stages as shown at block 340. The determination of error budgets and assignment of the error budgets to the graphics processing stages may be performed once per graphics frame, in some embodiments, or more or less frequently, such as once per tile, once per a portion of a frame, once per a pre-determined number of frames, and/or at application startup (e.g., based on user-defined error-control settings and/or predetermined complexity metrics for the application's graphics). In some embodiments, the global error-control unit 170 has complete knowledge of the local error-control processes, and explicitly sets configuration parameters for each of the local error-control blocks. In others, the global error-control unit 170 calculates numerical error limits for one or more of the stages, so that the stage may itself determine which approximation technique or techniques may be used, if any.

In some embodiments, the stage-specific error budgets may be individually determined, while in still others, two or more stages may be controlled with a single error budget message. For example, one or more stages may have a few fixed approximation modes from which the global error-control unit 170 might select. For instance, these stages might have a “Mode 1,” or “Low Error” setting, representing the highest quality of rendering. In this mode, these stages might use maximum numerical precision and lossless compression. A “Mode 2,” or “Medium Error” setting might represent a medium quality setting, with slight lower numerical precision and/or “mild” lossy compression, while a “Mode 3,” or “High Error” setting might indicate the lowest quality. This last mode may use the highest compression ratios and lowest numerical precision, while yielding the best improvements in speed and/or power consumption. In an embodiment employing these fixed modes, the global error-control unit 170 may assign an error budget to one or more of these stages by simply selecting the desired mode, either individually, or for a group of stages.

In some embodiments, the global error-control unit 170 forms a global error measure, τ_{GLOBAL}, based on the collected error data. In some embodiments, such as where the collected error data comprises numerical error measurements or estimates for the stage-specific errors, this global error measure may be computed as a weighted sum of the stage-specific errors. Thus, for example, the global error measure may be calculated generally as:

$${τ}_{GLOBAL} = {\sum }_{i} {τ}_{i} \cdot {w}_{i} ,$$

where τᵢ is a reported error value for stage i, and wᵢ is a corresponding stage-specific weighting factor. In some embodiments, error-control data from one or more stages may be converted into a numerical figure before computing a global error measure. In some embodiments, the global error measure may be computed as a rolling average over several frames (e.g., 10 frames), to avoid abrupt changes in the error budgets.

Those skilled in the art will appreciate that undesirable visual artifacts may result in some cases if the approximation schemes used by one or more processing stages are allowed to change dramatically from one frame to another. Thus, in some embodiments the global error-control unit may be configured to change the stage-specific error budgets gradually, under some circumstances, to avoid such artifacts, even if the global error exceeds the target level for one or more frames, tiles, pixels, or the like.

In any event, the global error measure τ_{GLOBAL} indicates the total accumulated error in a given frame or portion of a frame, and is used to control the local error thresholds. Of course, there are a variety of ways to compute the total error. Further, two or more “global” error measures, corresponding to different portions of the graphics pipeline or different aspects of the image quality, might also be computed and used to determine local error-control budgets.

In some embodiments, the local error-control units 160 and/or the global error-control unit 170 may continuously collect statistical data, such as mean and variance, of the accumulated error values. Based on this, the global error-control unit 170 may compute statistical error metrics rather than exact bounds for the approximation errors. This approach may be used, for example, to control stage-specific error budgets so that a certain percentage of the rendered pixels exceed a desired threshold, or so that the probability that a frame meets a certain threshold accuracy level is maintained at a desired level. Those skilled in the art will appreciate that in many applications, such as games, a few bad pixels may be acceptable if it can be ensured that the majority of pixels have low errors. Or, it may be acceptable to have an occasional “bad” frame as long as a smooth frame rate is maintained with generally acceptable image quality. By continuously monitoring the approximation errors or the statistics of the errors, the graphics processing hardware can automatically adapt to changes in the complexity of the graphics, and adjust the error budgets accordingly.

FIG. 4 illustrates an example of a logic flow diagram for a stage-specific error-control process that complements the global error-control process pictured in FIG. 3. The process illustrated in FIG. 4 begins with the receipt of a stage-specific error budget for a particular stage, as shown at block 410. As noted above, this error budget may comprise a numerical figure indicating a maximum error, mean error, or other quantitative representation of the targeted quality, or may comprise one or more parameters selecting a particular operating mode (e.g., one of “High,” “Medium,” or “Low” quality modes). In some embodiments, the error budget received from the global error-control unit 170 may instead comprise a parameter indicating that less error than previously introduced is desired, or that more error may be tolerated. In such embodiments, the signaling of the error budget may thus be implemented with a single bit, with one value indicating less error and the other indicating more. Other embodiments may require more complex signaling schemes.

With respect to FIG. 4, the example graphics processing stage is configured to selectively employ compression algorithms, for reducing memory bus usage, as a function of the received error budget. Thus, as shown at block 420, the local error-control unit 160 selects between the use of a lossy compression algorithm or a lossless compression algorithm, depending on the error budget. As was discussed above in connection with FIG. 2, this determination may be based on a test of whether the lossy compression algorithm will result in an accumulated error metric that exceeds the error budget.

As shown at blocks 430 and 440, if a lossy algorithm is selected, a degree of compression may be further selected, based on the error budget. Thus, a higher error budget may permit the use of a compression algorithm with a higher compression ratio. Alternatively, the higher error budget may permit a lossy compression algorithm with a fixed compression ratio to be used two or more times in the same graphics processing cycle, to achieve a higher degree of compression.

Those skilled in the art will appreciate that the error-control process illustrated in FIG. 4 is but one possible approach. A similar logic flow may be employed to select between a high-precision numerical calculation and a lower-precision, but faster, calculation. Thus, generally speaking, a process similar to that of FIG. 4 may be used to adjust a degree of data compression, a degree of data precision, or both, based on the stage-specific error budget received from the global error-control unit 170. The process illustrated in FIG. 4 may be employed once for a given frame or sequence of frames, once per a pre-determined time unit, or may be repeated multiple times during the processing of a single frame. Thus, for example, the processing of a given frame in a certain stage may begin with the use of a lossy compression algorithm, transitioning to a lossless algorithm as the stage-specific error budget is neared or exceeded.

Those skilled in the art will appreciate that the distributed error-control structure illustrated in FIG. 1 provides tremendous flexibility, allowing graphics quality to be traded for reductions in memory bandwidth requirements and improved battery life, while keeping the quality of the rendered images at acceptable levels. Although the general operation of this distributed error-control structure has been described above with reference to FIGS. 2-4, this flexibility may be exploited in several additional ways, as demonstrated in the examples described below.

For instance, one potential problem with introducing an approximation at an early stage of the graphics pipeline is that it can be difficult to predict in advance how much the introduced error will contribute to the final error in the resulting image. Under some circumstances, a small error introduced early in the pipeline, such as an error introduced by the use of a lossy vertex compression algorithm, may cause a large error in the final rendered image. In some embodiments, then, an accumulated error metric is tracked and stored for use in controlling the local error-control units 160 during the rendering of subsequent frames. This accumulated error metric may correspond to an entire frame, a sequence of frames, or to a portion of a frame. Further, the accumulated error metric may correspond to all of the graphics pipeline, or just a portion, such as a vertex processing section or a pixel processing section.

For example, if the final error is small for one frame or several consecutive frames, the error budgets allocated by the global error-control unit 170 to one or more of the processing stages may be increased slightly for the processing of the current frame. Thus, the approximation errors in one or more of the stages may increase for the current frame; the global error-control unit 170 will receive error data from those stages indicating the degree or type of approximation error introduced. If the error in the final frame grows beyond an acceptable limit, the error budget for one or more stages is then tightened. In some embodiments, the error budget for all controlled stages may be tightened, while in others the error data received from the stages may be correlated with the final frame rendering errors to determine which stages are contributing the most, and thus which stages should be more tightly controlled.

This approach is effectively a delayed closed-loop error-control mechanism, permitting global error adaptation for the rendering process. By keeping only a relatively small number of prior error metrics in memory, it can be ensured that the graphics processing system adapts quickly, e.g., within a few frames, to changes in the precision requirements for handling the current data.

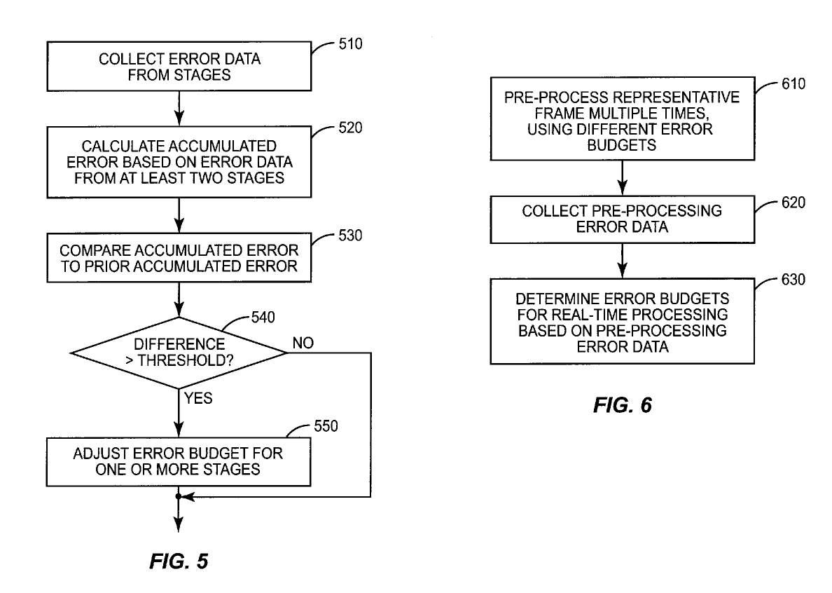

FIG. 5 is a logic flow diagram illustrating an exemplary implementation of such a closed-loop error-control process. At block 510, error data is collected from one or more pipelined processing stages, as discussed above. At block 520, an accumulated error is calculated, based on error data from two or more stages. As noted above, this accumulated error may correspond to an entire frame or a portion of a frame, and may correspond to all or part of the graphics pipeline.

At block 530, the most recent accumulated error is compared to one or more prior accumulated errors, to determine whether a change in the allocation of error budgets is warranted. In some embodiments, the global error-control unit 170 may simply determine whether the accumulated error has changed significantly, as shown in block 540, perhaps by comparing a pre-determined threshold value to the difference between the last error value and an average of several prior errors. If this comparison indicates that the error has changed to a significant degree, then the error-control budget for one or more stages is adjusted, as shown at block 550. If the change in the accumulated error reflects an undesired increase in error, this may include reducing a numerical error budget for a given stage, or dictating that a processing stage change from a “Medium” error process to a “Low” error process. In some cases, this may include directing a particular stage to switch from lossy compression to lossless compression. On the other hand, if the change in accumulated error indicates less error, so that more approximation is permitted, the error budgets for one or more stages may be loosened.

The process flow illustrated in FIG. 6 illustrates that the graphics processing error-control techniques disclosed herein may also be performed as a pre-process, instead of or as well as during run-time. For example, a game application might be configured to render a short sequence of representative frames at startup, as shown at block 610. One or more of these frames can be processed by the graphics pipeline, using varying error budgets for one or more of the stages. After collecting error data from these stages corresponding to these pre-processed frames, as shown at block 620, one or a few different settings or error-control parameters for use during real-time processing are computed, as shown at block 630.

Based on this pre-processing, the global error-control unit might determine, for instance, that a relatively low quality rendering process (employing more approximation techniques) is needed to maintain a desired level of performance, given the typical frames needed for this particular game. This setting, or these parameters, is thus specific to a particular combination of software application and processing hardware. The advantage of performing error estimation as a pre-process is that the run-time cost of computing errors and computing error thresholds can be reduced or eliminated entirely. Thus, some embodiments may rely entirely on a pre-process error-control method, using the results to set static error budgets for one or more of the processing stages for the duration of the application. Other embodiments may use the pre-processing approach to simplify subsequent run-time error control. For instance, the pre-processing approach may be combined with a run-time error-control process that dynamically controls the error budgets for fewer than all of the stages, or that dynamically controls the error budgets less frequently, or within a constrained range of settings.

In yet other embodiments, pre-computation of errors can be performed in the design phase of the graphics application (i.e., before the application is distributed to the user) against a range of hardware configurations and/or user-defined error-control preferences. Pre-computed errors, error budgets, and the like may be stored in the same medium as the executable application, or along with other graphics data for the application, and retrieved at startup and/or run-time by the global error-control unit 170 to determine and assign error-control budgets to the local graphics processing stages. In embodiments where such error data may be pre-computed for a number of different hardware configurations or user preferences, the data corresponding to the configuration and/or settings that most closely resemble the current hardware and user preferences may be selected at application startup, either automatically or with input from the application user.

The general error-control structure illustrated in FIG. 1 also permits the inclusion of end-user input into the error-control process, thus allowing the end-user to indicate how much error he or she is willing to tolerate. As noted above, allowing larger errors facilitates faster performance and/or lower power consumption. The latter is especially important in mobile devices; permitting the user to adjust the error-control process gives the user the choice of extending battery life by slightly reducing the rendered image quality. A similar feature may also be important in desktop computers and game consoles, since the user may wish to increase the rendering performance (e.g., a higher frame-rate) by accepting a slight loss of image quality in some applications.

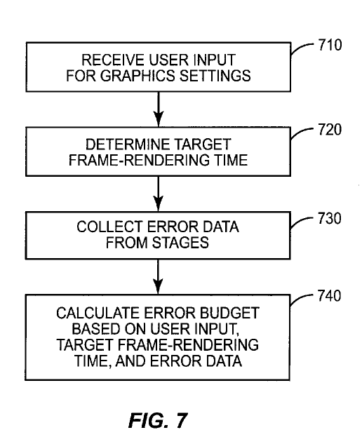

An exemplary method for using user input to determine error budgets for one or more processing stages is illustrated in FIG. 7. The user input to the error-control process can be implemented either as a general, relatively static, setting (e.g., set by the user through a menu item), or more dynamically configured, for example during game play using a particular combination of controller keys. In some embodiments of the invention, then, a user quality setting or performance setting is used, instead of or along with error data from one or more pipelined processing stages, to determine the error budgets.

In addition to user input, other metrics or targets may be used in a dynamic calculation of the error budgets for the pipelined processing stages. For example, in some embodiments, a global error-control unit may automatically adjust the allocated error budgets based on the complexity of the graphics currently being rendered. This could ensure that a consistent frame rate is maintained, for example, by lowering the image quality when rendering very complex graphics. For some graphics applications, this may increase the perceived performance, for example by ensuring at least a minimum frame rate needed for smooth game play. Of course, since it can be difficult to predict how a particular game or other application will appear when rendered at different levels of approximation, it may be desirable to combine such automatic error control with the user input described above.

Accordingly, referring once more to FIG. 7, user input for a graphics setting is received by a global error-control unit, as shown in block 710. As noted above, the user input may be received via a menu setting, or through some in-game activation method, such as a particular key sequence or combination.

At block 720, a target frame-rendering time is determined. This may comprise simply retrieving a pre-determined value from memory. In other embodiments, however, the target frame-rendering time may be determined from the user settings, from the complexity of the current graphics data being rendered, from the type of application, from the type of equipment being used, etc.

In any case, as shown at block 730, error data is collected from one or more stages, as described above. This error data is used, along with the user and the target frame-rendering time to calculate an error budget for one or more stages, as shown at block 740.

Those skilled in the art will appreciate that the process illustrated in FIG. 7, like most of the other processes described herein, is inherently dynamic. However, the rate at which this process repeats can vary from one embodiment to the next. Thus, in some embodiments the error budgets for all controlled stages may be re-calculated and re-allocated for each frame. In other embodiments the same calculations may be repeated, but less frequently, such as every third frame, or every tenth frame. In still others, error budgets for several stages may be computed in a sequential fashion. For instance, an error budget for only a single stage may be computed and updated for a given frame, while the error budgets for other stages are held constant. Error budgets for other stages may be computed for subsequent frames.

Referring once more to FIG. 1, in view of the various methods and techniques described above, those skilled in the art will appreciate that graphics processing circuit 100 may be a dedicated graphics rendering device for a personal computer, workstation, game console, mobile phone, or the like, or may be a general purpose processing system programmed to performed graphics processing operations. Graphics processing circuit 100 may comprise one or more microprocessors, microcontrollers, digital signal processors, and/or customized hardware, and may be implemented as a standalone chip or as part of an application-specific integrated circuit (ASIC) that includes other functions. In many embodiments, graphics processing circuit 100 comprises on-board random access memory and/or cache memory.

Depth buffer 136, color buffer 138 and other buffers used by graphics processing circuit 100 are typically implemented using fast random access memory (RAM), such as static RAM (SRAM), although other memory types, such as DRAM, flash, etc., are possible. All or parts of one or more of the buffers may be implemented with one or more separate memory circuits or chips, or may be implemented as part of an ASIC that may also include all or a portion of the remainder of graphics processing circuit 100.

Graphics processing circuit 100 is programmed, using software, firmware, or some combination of the two, and/or hardwired to carry out one or more of the methods described herein. Thus, graphics processing circuit 100 is programmed, in some embodiments, to process vertices, pixels, graphics primitives, or other graphical data, in each of two or more pipelined processing stages, according to a stage-specific error budget. In some embodiments, graphics processing circuit 100 may include other stages that operate according to fixed error-control processes, or that are configured to operate without introducing error into the overall graphics processing process. In any event, the graphics processing circuit is further programmed to collect error data from each of the two or more stages, and to assign error budgets, based on the collected error data, to each of the two or more stages. Those skilled in the art will appreciate that one or more of the operations of graphics processing circuit 100 may be performed by hardwired circuits while others are performed by one or more software-programmable processor elements.

With the above range of variations and applications in mind, it should be understood that the present invention is not limited by the foregoing description, nor is it limited by the accompanying drawings. Instead, the present invention is limited only by the following claims, and their legal equivalents.

What is claimed is:

1. A graphics processing circuit for rendering three-dimensional graphics data, the graphics processing circuit comprising:
a graphics pipeline comprising pipelined processing stages, wherein each of two or more stages is configured to process at least one of graphics primitives, vertices, tiles, and pixels, according to a stage-specific error budget; and
a global error-control unit configured to determine error budgets for each of the two or more stages, based on at least one of error data received from the two or more stages, predetermined scene complexity data, and user-defined error settings, and to assign the error budgets to the two or more stages.

2. The graphics processing circuit of claim 1, wherein at least one of the stages is configured to measure a stage-specific processing error and to report the measured error to the global error-control unit as error data.

3. The graphics processing circuit of claim 2, wherein the measured error comprises a statistical measure corresponding to errors introduced to a plurality of at least one of graphics primitives, vertices, tiles, and pixels.

4. The graphics processing circuit of claim 1, wherein at least one of the stages is configured to estimate a stage-specific processing error and to report the estimated error to the global error-control unit as error data.

5. The graphics processing circuit of claim 4, wherein the estimated error comprises a statistical measure corresponding to errors introduced to a plurality of at least one of graphics primitives, vertices, tiles, and pixels.

6. The graphics processing circuit of claim 1, wherein the global error-control unit is configured to retrieve error data stored in a shared memory by at least one of the stages, for use in determining the error budgets.

7. The graphics processing circuit of claim 1, wherein at least one of the stages is configured to select one of a lossy or lossless compression algorithm for processing graphics data, based on the stage-specific error budget received from the global error-control unit.

8. The graphics processing circuit of claim 1, wherein at least one of the stages is configured to adjust a degree of data compression, a degree of data precision, or both, for processing graphics data, based on the stage-specific error budget received from the global error-control unit.

9. The graphics processing circuit of claim 1, wherein the global error-control unit is configured to calculate an accumulated error based on error data received from two or more stages and to adjust the error budget for at least one stage based on the accumulated error.

10. The graphics processing circuit of claim 1, wherein the global error-control unit is configured to compare recent error data to prior error data and to adjust the error budget for at least one stage based on the comparison.

11. The graphics processing circuit of claim 10, wherein the global error-control unit is configured to compare recent error data to prior error data by comparing a first accumulated error corresponding to the recent error data to a second accumulated error corresponding to the prior error data.

12. The graphics processing circuit of claim 1, wherein the global error-control unit is configured to calculate the error budgets for one or more stages based on a quality setting or performance setting selected by a user.

13. The graphics processing circuit of claim 1, wherein the two or more stages are configured, during a pre-processing cycle, to process at least one graphics frame multiple times, using different stage-specific error budgets, and to report corresponding pre-processing error data to the global error-control unit, and wherein the global error-control unit is configured to assign error budgets for real-time graphics processing based on the reported pre-processing error data.

14. The graphics processing circuit of claim 1, wherein the global error-control unit is configured to calculate the error budgets for one or more stages based on a complexity metric corresponding to one or more graphics frames.

15. The graphics processing circuit of claim 1, wherein the global error-control unit is configured to calculate the error budgets for the one or more stages further based on a target frame-rendering time.

16. A method of processing three-dimensional graphics data, the method comprising:
determining a stage-specific error budget for each of two or more pipelined graphics processing stages, based on at least one of error data collected from the two or more stages, predetermined scene complexity data, and user-defined error settings;
assigning the stage-specific error budgets to each of the two or more stages; and
processing at least one of graphics primitives, vertices, tiles, and pixels, in each of the pipelined graphics processing stages, according to the stage-specific error budgets.

17. The method of claim 16, further comprising measuring a stage-specific processing error for at least one stage, wherein the error data collected from the at least one stage comprises the measured stage-specific processing error.

18. The method of claim 17, wherein measuring the stage-specific processing error comprises calculating a statistical measure corresponding to errors introduced to a plurality of at least one of graphics primitives, vertices, tiles, and pixels.

19. The method of claim 16, further comprising estimating a stage-specific processing error for at least one stage, wherein the error data collected from the at least one stage comprises the estimated stage-specific processing error.

20. The method of claim 19, wherein measuring the stage-specific processing error comprises calculating a statistical measure corresponding to errors introduced to a plurality of at least one of graphics primitives, vertices, tiles, and pixels.

21. The method of claim 16, further comprising retrieving error data stored in a shared memory by at least one of the stages, for use in determining the error budgets.

22. The method of claim 16, wherein processing at least one of graphics primitives, vertices, tiles, and pixels, in at least one of the stages comprises selecting one of a lossy or lossless compression algorithm for processing graphics data, based on the stage-specific error budget received from the global error-control unit.

23. The method of claim 16, wherein processing at least one of graphics primitives, vertices, tiles, and pixels, in at least one of the stages comprises adjusting a degree of data compression, a degree of data precision, or both, for processing graphics data, based on the stage-specific error budget received from the global error-control unit.

24. The method of claim 16, wherein determining the stage-specific error budgets comprises:
calculating an accumulated error based on error data received from two or more stages; and
adjusting the error budget for at least one stage based on the accumulated error.

25. The method of claim 16, wherein determining the stage-specific error budgets comprises:
comparing recent error data to prior error data; and
adjusting the error budget for at least one stage based on the comparison.

26. The method of claim 25, wherein comparing recent error data to prior error data comprises comparing a first accumulated error corresponding to the recent error data to a second accumulated error corresponding to the prior error data.

27. The method of claim 16, wherein determining the stage-specific error budgets comprises calculating the error budgets for one or more stages based on a quality setting or performance setting selected by a user.

28. The method of claim 16, comprising, during a pre-processing cycle, processing at least one graphics frame multiple times in the two or more stages, using different stage-specific error budgets, and collecting corresponding pre-processing error data, wherein determining the stage-specific error budgets comprises determining error budgets for real-time graphics processing based on the reported pre-processing error data.

29. The method of claim 16, wherein determining the stage-specific error budgets comprises calculating the error budgets for one or more stages based on a complexity metric corresponding to one or more graphics frames.

30. The method of claim 16, further comprising calculating the error budgets for the one or more stages further based on a target frame-rendering time.
